(19) United States
(12) Patent Application Publication
(10) Pub. No.: US 2019/0279119 A1
(43) Pub. Date: Sep. 12, 2019

(54) VEHICLE CONTROL SYSTEM, VEHICLE CONTROL METHOD, AND STORAGE MEDIUM

(71) Applicant: HONDA MOTOR CO., LTD., Tokyo (JP)

(72) Inventors: Takafumi Hirose, Wako-shi (JP); Naoto Yasuda, Wako-shi (JP); Yuki Oshitani, Tokyo (JP); Susumu Iwamoto, Tokyo (JP)

(21) Appl. No.: 16/288,191

(22) Filed: Feb. 28, 2019

(30) Foreign Application Priority Data
Mar. 6, 2018 (JP) 2018-039732

(51) Int. Cl. G06Q 10/02; G01C 21/34; G05D 1/00; G06Q 50/30

(52) U.S. Cl. CPC G06Q 10/02; G01C 21/3415; G05D 2201/0213; G06Q 50/30; G05D 1/0088

(57) ABSTRACT

A vehicle control system includes: a generator (184) configured to generate a first travel plan of an automatic driving vehicle; a controller (120, 160, 180) configured to cause the automatic driving vehicle to travel based on the first travel plan generated by the generator; and an acquirer (182) configured to acquire a change request for changing the first travel plan generated by the generator. The generator generates a second travel plan satisfying the change request in accordance with a situation of the automatic driving vehicle when the acquirer acquires the change request in a situation in which an authorized person who has a predetermined authority to use the automatic driving vehicle does not board the automatic driving vehicle and the automatic driving vehicle starts traveling in accordance with the first travel plan.

### CROSS-REFERENCE TO RELATED APPLICATION

Priority is claimed on Japanese Patent Application No. 2018-039732, filed Mar. 6, 2018, the content of which is incorporated herein by reference.

### BACKGROUND

### Field of the Invention

The present invention relates to a vehicle control system, a vehicle control method, and a storage medium.

### Description of Related Art

In recent years, a service in which shared cars are used has attracted attention. With regard to this, a service in which, when a request is received from a registered person registered in advance as a person planning to use a vehicle, the usage schedules of users are referred to, and it is determined whether or not a schedule is conflicting, and when there is no conflict, a schedule according to the received request is registered, is known (for example, see Japanese Unexamined Patent Application, First Publication No. 2017-191371).

### SUMMARY

However, in systems of the related art, cases in which a schedule is desired to be changed have not been examined sufficiently and sufficient uses of vehicles may sometimes not be achieved.

An aspect of the present invention has been realized in view of such circumstances and an object of the present invention is to provide a vehicle control system, a vehicle control method, and a storage medium capable of expanding utilization of a vehicle when a change in a use schedule of the vehicle is desired.

The vehicle control system, the vehicle control method, and the storage medium according to the present invention adopt the following configurations.

(1) According to an aspect of the present invention, there is provided a vehicle control system including: a generator configured to generate a first travel plan of an automatic driving vehicle; a controller configured to cause the automatic driving vehicle to travel based on the first travel plan generated by the generator; and an acquirer configured to acquire a change request for changing the first travel plan generated by the generator. The generator generates a second travel plan satisfying the change request in accordance with a situation of the automatic driving vehicle when the acquirer acquires the change request in a situation in which an authorized person who has a predetermined authority to use the automatic driving vehicle does not board the automatic driving vehicle and the automatic driving vehicle starts traveling in accordance with the first travel plan.

(2) In the forgoing (1) aspect, the change request may include a request for changing a travel condition including at least one of time information and positional information included in the first travel plan. As the second travel plan, the generator may generate a travel plan satisfying a travel condition related to the requested change.

(3) In the forgoing (1) aspect, the change request may include return to a position at which the automatic driving vehicle allows the authorized person to disembark. As the second travel plan, the generator may generate a travel plan for causing the automatic driving vehicle to travel toward the position at which the automatic driving vehicle allows the authorized person to disembark.

(4) In the forgoing (1) aspect, as the second travel plan, the generator may generate a travel plan in which a place at which use of the automatic driving vehicle by a person other than the authorized person ends is set as a starting place when the acquirer acquires the change request and the automatic driving vehicle allows the person other than the authorized person to board.

(5) In the forgoing (1) aspect, the vehicle control system may further include a notifier configured to notify the authorized person of the second travel plan generated by the generator.

(6) In the forgoing (1) aspect, the generator may generate a third travel plan which is a substitute when the generator is not able to generate the second travel plan.

(7) In the forgoing (1) aspect, the vehicle control system may further include an alternative generator configured to search for another automatic driving vehicle which is able to execute a travel plan satisfying the change request when the generator is not able to generate the second travel plan.

(8) In the forgoing (1) aspect, the controller may cause the automatic driving vehicle to travel based on the second travel plan generated by the generator.

(9) According to another aspect of the invention, there is provided a vehicle control method of causing one or more computers to perform: generating a first travel plan of an automatic driving vehicle; causing the automatic driving vehicle to travel based on the first travel plan generated by the generator; and acquiring a change request for changing the first travel plan generated by the generator. A second travel plan satisfying the change request is generated in accordance with a situation of the automatic driving vehicle when the change request is acquired in a situation in which an authorized person who has a predetermined authority to use the automatic driving vehicle does not board the automatic driving vehicle and the automatic driving vehicle starts traveling in accordance with the first travel plan.

(10) According to still another aspect of the invention, there is provided a program causing one or more computers to perform: generating a first travel plan of an automatic driving vehicle; causing the automatic driving vehicle to travel based on the first travel plan generated by the generator; and acquiring a change request for changing the first travel plan generated by the generator. A second travel plan satisfying the change request is generated in accordance with a situation of the automatic driving vehicle when the change request is acquired in a situation in which an authorized person who has a predetermined authority to use the automatic driving vehicle does not board the automatic driving vehicle and the automatic driving vehicle starts traveling in accordance with the first travel plan.

According to the foregoing (1) to (10) aspects, it is possible to expand utilization of a vehicle when a change in a use schedule of the vehicle is desired.

### BRIEF DESCRIPTION OF THE DRAWINGS

FIG. 1 is a diagram illustrating a configuration of a vehicle control system in which a vehicle control device is used according to a first embodiment.

FIG. 2 is a diagram illustrating a configuration of a vehicle control device 5 according to the first embodiment.

FIG. 3 is a diagram illustrating a functional configuration of a first controller, a second controller, and a third controller.

FIG. 4 is a flowchart illustrating an example of a flow of a process by the third controller.

FIG. 5 is a diagram illustrating a configuration of a management device according to a second embodiment.

FIG. 6 is a diagram illustrating an example of a hardware configuration of an automatic driving control device according to an embodiment.

### DESCRIPTION OF EMBODIMENTS

### First Embodiment

Hereinafter, embodiments of a vehicle control system, a vehicle control method, and a storage medium according to the present invention will be described with reference to the drawings. Hereinafter, a case in which left-hand traffic regulations are applied will be described. When right-hand traffic regulations are applied, the right and left may be switched.

### [Overall Configuration]

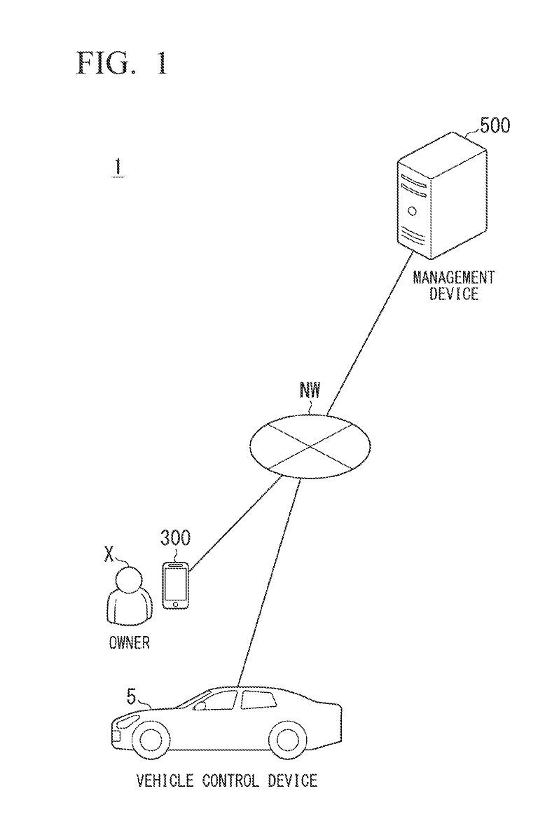

FIG. 1 is a diagram illustrating a configuration of a vehicle control system 1 in which a vehicle control device is used according to a first embodiment. The vehicle control system 1 is realized by one or more processors (computers). The vehicle control system 1 includes, for example, one or more vehicle control devices 5, one or more terminal devices 300, and a management device 500. The vehicle control device 5 is an in-vehicle device mounted in an automatic driving vehicle that has an automatic driving function. The automatic driving vehicle is, for example, a private vehicle of an owner X. That is, the owner X is an owner of the automatic driving vehicle. The terminal device 300 is a terminal device owned by the owner X and is, for example, a mobile phone such as a smartphone or a portable terminal device such as a tablet terminal, a notebook PC, or a personal digital assistant (PDA) that has at least a communication function and an information input and output function. The management device 500 communicates with the vehicle control device 5 and the terminal device 300 to supply various types of information.

The vehicle control device 5, the terminal device 300, and the management device 500 are connected to each other by a network NW and communicate with each other via the network NW. The network NW includes, for example, some or all of a wide area network (WAN), a local area network (LAN), the Internet, a dedicated line, a wireless base station, a provider, and the like.

Here, an example of an application scenario of the vehicle control system 1 according to the embodiment will be described. For example, it is assumed that the owner X boards the automatic driving vehicle, starts from his or her home, and arrives at a shopping mall which is a destination before noon. The owner X is scheduled to stay at the shopping mall until evening. In such a scenario, the owner X can be supplied with a predetermined service during a period in which the automatic driving vehicle is not being used from the arrival at the shopping mall to return therefrom. The predetermined service includes, for example, a cleaning service, a car sharing service, a taxi service, and a charging service. For example, the cleaning service is a service in which the automatic driving vehicle of the owner X is caused to travel to cleaning equipment, cleaning work or the like at the cleaning equipment (cleaning of the vehicle, cleaning of the interior of the vehicle, changing of the arrangement of the seats, inspection, other maintenance, and the like) is completed, and then the automatic driving vehicle travels to a designated place. For example, the car sharing service is a service in which the automatic driving vehicle of the owner X is utilized as a vehicle used by a user other than the owner X (hereinafter referred to as a shared car). For example, the taxi service is a service in which the automatic driving vehicle of the owner X is utilized as a taxi. For example, the charging service is a service in which the automatic driving vehicle of the owner X travels to charging equipment for charging a battery of an electric vehicle or a gas station, the automatic driving vehicle is charged with electricity or supplied with gasoline at the charging equipment or the gas station, and then the automatic driving vehicle is traveled to a designated place.

Incidentally, such a predetermined service starts and then the owner X desires to change content of the predetermined service in some cases. For example, there is a case in which the owner X has left something in the automatic driving vehicle or a case in which the owner X advances or delays a time of returning home. When there is a change request from the owner X, the vehicle control system 1 performs a process of changing content of a service in which authorized person absence traveling is performed among such predetermined services. The authorized person absence traveling refers to traveling of an automatic driving vehicle according to a decided travel request in a state in which an authorized person does not board the automatic driving vehicle. The authorized person is a person who has a predetermined authority to use the automatic driving vehicle and includes, for example, the owner X or a person to which the owner X gives an authority.

When a predetermined service is supplied, the owner X sets service conditions including a type of service, a starting time, an ending time, a starting place (a place at which the vehicle starts at the starting time), and a returning place (a place at which the vehicle arrives at the ending time) in advance. For example, information indicating the service conditions set by the owner X is set using an interface of the terminal device 300 or the vehicle control device 5 and is managed in the vehicle control device 5 or the management device 500.

### [Vehicle Control Device 5]

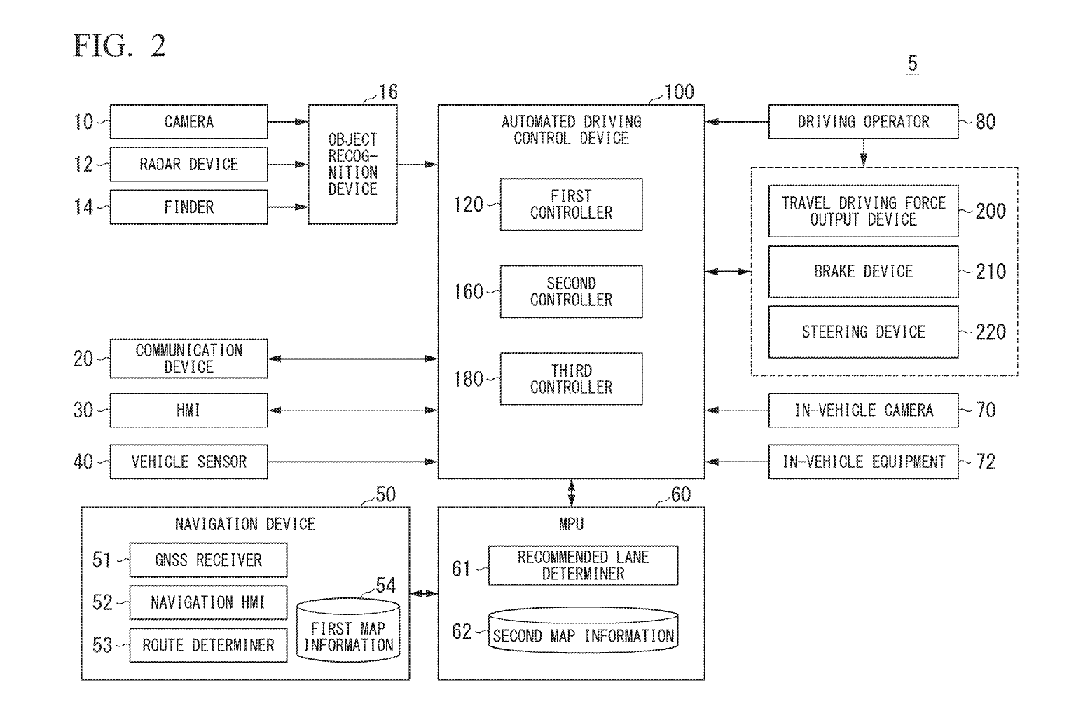

Next, the vehicle control device 5 will be described. FIG. 2 is a diagram illustrating a configuration of the vehicle control device 5 according to the first embodiment. A vehicle in which the vehicle control device 5 is mounted is, for example, a vehicle such as a two-wheeled vehicle, a three-wheeled vehicle, or a four-wheeled vehicle. A driving source of the vehicle includes an internal combustion engine such as a diesel engine or a gasoline engine, an electric motor, and a combination thereof. The electric motor operates using power generated by a power generator connected to the internal combustion engine or power discharged from a secondary cell or a fuel cell.

The vehicle control device 5 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, an in-vehicle camera 70, in-vehicle equipment 72, a driving operator 80, an automatic driving control device 100, a travel driving power output device 200, a brake device 210, and a steering device 220.

The devices and units are connected to each other via a multiplex communication line such as a controller area network (CAN) communication line, a serial communication line, or a wireless communication network. The configuration illustrated in FIG. 2 is merely exemplary, a part of the configuration may be omitted, and other constituents may be further added.

The camera 10 is, for example, a digital camera that uses a solid-state image sensor such as a charged coupled device (CCD) or a complementary metal oxide semiconductor (CMOS). The camera 10 is mounted on any portion of the automatic driving vehicle in which the vehicle control device 5 is mounted. In the case of forward imaging, the camera 10 is mounted on an upper portion of a front windshield, a rear surface of a rearview mirror, or the like. For example, the camera 10 repeatedly images the vicinity of the automatic driving vehicle periodically. The camera 10 may be a stereo camera.

The radar device 12 radiates radio waves such as millimeter waves to the vicinity of the automatic driving vehicle and detects radio waves (reflected waves) reflected from an object to detect at least a position (a distance and an azimuth) of the object. The radar device 12 is mounted on any portion of the automatic driving vehicle. The radar device 12 may detect a position and a speed of an object in conformity with a frequency modulated continuous wave (FM-CW) scheme.

The finder 14 is a light detection and ranging (LIDAR) finder. The finder 14 emits light to the vicinity of the automatic driving vehicle and measures scattered light. The finder 14 detects a distance to a target based on a time from light emission to light reception. The emitted light is, for example, a pulsed laser beam. The finder 14 is mounted on any portion of the automatic driving vehicle.

The object recognition device 16 performs a sensor fusion process on detection results of some or all of the camera 10, the radar device 12, and the finder 14 and recognizes a position, a type, a speed, and the like of an object. The object recognition device 16 outputs a recognition result to the automatic driving control device 100. The object recognition device 16 may output the detection results of the camera 10, the radar device 12, and the finder 14 without change to the automatic driving control device 100. The object recognition device 16 may be omitted from the vehicle control device 5.

The communication device 20 communicates with other vehicles around the automatic driving vehicle using, for example, a cellular network, a Wi-Fi network, Bluetooth (registered trademark), dedicated short range communication (DSRC), or the like or communicates with various server devices via wireless base stations.

The HMI 30 suggests various types of information to occupants of the automatic driving vehicle and receives input operations by the occupants. The HMI 30 includes various display devices, speakers, buzzers, touch panels, switches, and keys.

The vehicle sensor 40 includes a vehicle speed sensor that detects a speed of the automatic driving vehicle, an acceleration sensor that detects acceleration, a yaw rate sensor that detects an angular velocity around a vertical axis, and an azimuth sensor that detects a direction of the automatic driving vehicle.

The navigation device 50 includes, for example, a global navigation satellite system (GNSS) receiver 51, a navigation HMI 52, and a route determiner 53. The navigation device 50 retains first map information 54 in a storage device such as a hard disk drive (HDD) or a flash memory. The GNSS receiver 51 specifies a position of the automatic driving vehicle based on signals received from GNSS satellites. The position of the automatic driving vehicle may be specified or complemented by an inertial navigation system (INS) using an output of the vehicle sensor 40. The navigation HMI 52 includes a display device, a speaker, a touch panel, and a key. The navigation HMI 52 may be partially or entirely common to the above-described HMI 30. The route determiner 53 decides, for example, a route from a position of the automatic driving vehicle specified by the GNSS receiver 51 (or any input position) to a destination input by an occupant using the navigation HMI 52 (hereinafter referred to as a map route) with reference to the first map information 54. The first map information 54 is, for example, information in which a road form is expressed by links indicating roads and nodes connected by the links. The first map information 54 may include curvatures of roads and point of interest (POI) information. The map route is output to the MPU 60. The navigation device 50 may perform route guidance using the navigation HMI 52 based on a map route. The navigation device 50 may be realized by, for example, a function of a terminal device such as a smartphone or a tablet terminal possessed by the occupant. The navigation device 50 may transmit a current position and a destination to a navigation server via the communication device 20 to acquire the same route as a map route from the navigation server.

The MPU 60 includes, for example, a recommended lane determiner 61 and retains second map information 62 in a storage device such as an HDD or a flash memory. The recommended lane determiner 61 divides a map route provided from the navigation device 50 into a plurality of blocks (for example, divides the map route in a vehicle movement direction every 100 [m]) and decides a recommended lane for each block with reference to the second map information 62. The recommended lane determiner 61 decides in which lane the vehicle travels from the left.

When there is a branching spot on a map route, the recommended lane determiner 61 decides a recommended lane so that the automatic driving vehicle can travel along a reasonable route for traveling to a branching destination.

The second map information 62 is map information with higher precision than that of the first map information 54. The second map information 62 includes, for example, information regarding the middles of lanes or information regarding boundaries of lanes. The second map information 62 may include road information, traffic regulation information, address information (address and postal number), facility information, and telephone number information. The second map information 62 may be updated frequently when the communication device 20 communicates with other devices.

The in-vehicle camera 70 is, for example, a digital camera in which a solid-state image sensor such as CCD or CMOS is used. The in-vehicle camera 70 is fitted at any position to image the inside of the automatic driving vehicle.

The driving operator 80 includes, for example, an accelerator pedal, a brake pedal, a shift lever, a steering wheel, a steering variant, a joystick, and other operators. A sensor that detects whether there is an operation or an operation amount is mounted on the driving operator 80. A detection result is output to the automatic driving control device 100 or some or all of the travel driving power output device 200, the brake device 210, and the steering device 220.

The automatic driving control device 100 includes, for example, a first controller 120 and a second controller 160. Each of the first controller 120 and the second controller 160 is realized, for example, by causing a hardware processor such as a central processing unit (CPU) to execute a program (software). One or both of these constituent elements may be realized by hardware (a circuit unit including circuitry) such as a large scale integration (LSI), an application specific integrated circuit (ASIC), a field-programmable gate array (FPGA), or a graphics processing unit (GPU) or may be realized by software and hardware in cooperation. The program may be stored in advance in a storage device such as an HDD or a flash memory of the automatic driving control device 100 or may be stored in a removable storage medium such as a DVD or a CD-ROM to be installed in the HDD or the flash memory of the automatic driving control device 100 when the storage medium is mounted in the drive device.

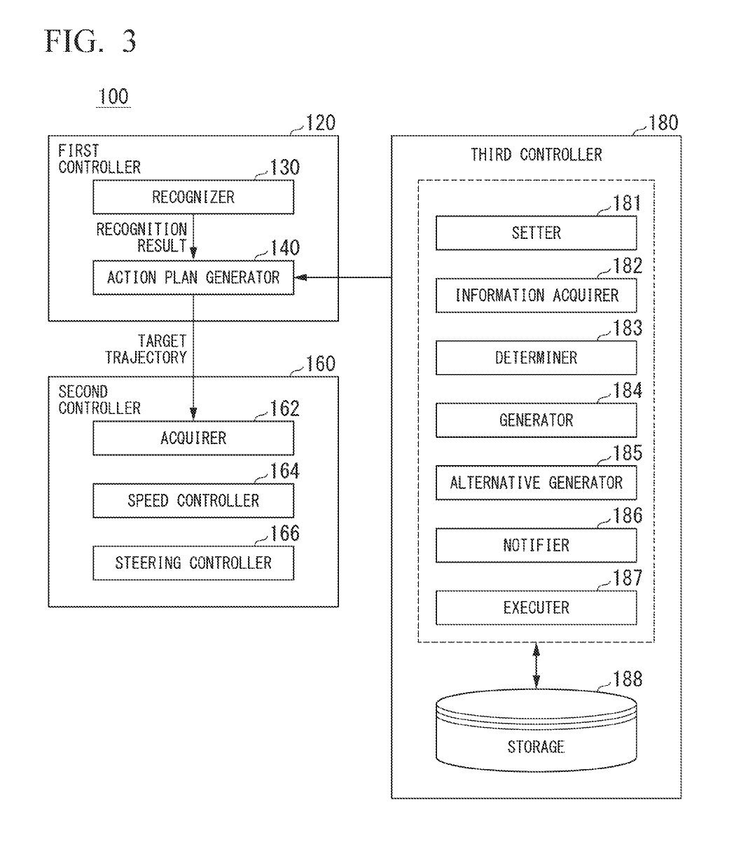

FIG. 3 is a diagram illustrating a functional configuration of the first controller 120, the second controller 160, and the third controller 180. The first controller 120 includes, for example, a recognizer 130 and an action plan generator 140. The first controller 120 or the third controller 180 concurrently realizes, for example, a function using artificial intelligence (AI) and a function using a pre-given model. For example, an “intersection recognition” function may be realized by concurrently performing recognition of an intersection by deep learning or the like and recognition based on a pre-given condition (there is a sign, a road sign, and the like for which pattern matching is possible) and scoring both for comprehensive evaluation. In this way, reliability of automatic driving is guaranteed.

The recognizer 130 recognizes states such as a position, a speed, and acceleration of objects around the automatic driving vehicle based on information input from the camera 10, the radar device 12, and the finder 14 via the object recognition device 16. The position of an object is recognized as, for example, a position on absolute coordinates in which a representative point (the center of gravity, a center of a driving shaft, or the like) of the automatic driving vehicle is set as the origin and is used for control. The position of an object may be expressed as a representative point of the center of gravity, a corner, or the like of the object or may be represented in an expressed region. A “state” of an object may include acceleration or jerk of the object or an “action state” (for example, whether to change a lane or attempt to change a lane).

For example, the recognizer 130 recognizes a lane (traveling lane) in which the automatic driving vehicle is traveling. For example, the recognizer 130 recognizes a traveling lane by comparing patterns of road mark lines (for example, arrangement of continuous lines and broken lines) obtained from the second map information 62 with patterns of road mark lines around the automatic driving vehicle recognized from images captured by the camera 10. The recognizer 130 may recognize a traveling lane by mainly recognizing boundaries (road boundaries) including road mark lines or shoulders, curbstones, median strips, and guardrails without being limited to road mark lines. In this recognition, the position of the automatic driving vehicle acquired from navigation device 50 or a process result by INS may be added. The recognizer 130 recognizes temporary stop lines, obstacles, red signals, toll gates, other road events.

The recognizer 130 recognizes a position or an attitude of the automatic driving vehicle with respect to the traveling lane when the recognizer 130 recognizes the traveling lane. For example, the recognizer 130 may recognize a separation from the middle of a lane of a reference point of the automatic driving vehicle and an angle formed with a line extending along the middle of a lane in the traveling direction of the automatic driving vehicle as a relative position and attitude of the automatic driving vehicle to the traveling lane. Instead of this, the recognizer 130 may recognize a position or the like of the reference point of the automatic driving vehicle with respect to a side end portion (a road mark line or a road boundary) of any traveling lane as the relative position of the automatic driving vehicle to the traveling lane.

In principle, the action plan generator 140 travels along a recommended lane decided by the recommended lane determiner 61 and further generates a target trajectory along which the automatic driving vehicle travels in future automatically (independently from an operation of a driver or the like) to handle a surrounding situation of the automatic driving vehicle. The target trajectory includes, for example, a speed component. For example, the target trajectory is expressed by sequentially arranging spots (trajectory points) at which the automatic driving vehicle arrives. The trajectory point is a spot at which the automatic driving vehicle arrives for each predetermined travel distance (for example, about several [m]) by a distance along a road. Apart from this, target speed and target acceleration at each predetermined sampling time (for example, about 0 decimal point [sec]) are generated as a part of the target trajectory. The trajectory point may be a position at which the automatic driving vehicle arrives at the sampling time for each predetermined sampling time. In this case, information regarding the target speed or the target acceleration is expressed at intervals of the trajectory point.

The action plan generator 140 may set an automatic driving event when the target trajectory is generated. As the automatic driving event, there is a constant speed traveling event, a low speed track traveling event, a lane changing event, a branching event, a joining event, a takeover event, and the like. The action plan generator 140 generates the target trajectory in accordance with an activated event.

The second controller 160 controls the travel driving power output device 200, the brake device 210, and the steering device 220 so that the automatic driving vehicle passes along the target trajectory generated by the action plan generator 140 on a scheduled time.

The second controller 160 includes, for example, an acquirer 162, a speed controller 164, and a steering controller 166. The acquirer 162 acquires information regarding the target trajectory (trajectory points) generated by the action plan generator 140 and stores the information in a memory (not illustrated). The speed controller 164 controls the travel driving power output device 200 or the brake device 210 based on a speed element incidental to the target trajectory stored in the memory. The steering controller 166 controls the steering device 220 in accordance with a curve state of the target trajectory stored in the memory. Processes of the speed controller 164 and the steering controller 166 are realized, for example, by combining feed-forward control and feedback control. For example, the steering controller 166 performs the feed-forward control in accordance with a curvature of a road in front of the automatic driving vehicle and the feedback control based on separation from the target trajectory in combination.

The travel driving power output device 200 outputs a travel driving force (torque) for traveling the vehicle to a driving wheel. The travel driving power output device 200 includes, for example, a combination of an internal combustion, an electric motor and a transmission, and an ECU controlling these units. The ECU controls the foregoing configuration in accordance with information input from the second controller 160 or information input from the driving operator 80.

The brake device 210 includes, for example, a brake caliper, a cylinder that transmits a hydraulic pressure to the brake caliper, an electronic motor that generates a hydraulic pressure to the cylinder, and a brake ECU. The brake ECU controls the electric motor in accordance with information input from the second controller 160 or information input from the driving operator 80 such that a brake torque in accordance with a brake operation is output to each wheel. The brake device 210 may include a mechanism that transmits a hydraulic pressure generated in accordance with an operation of the brake pedal included in the driving operator 80 to the cylinder via a master cylinder as a backup. The brake device 210 is not limited to the above-described configuration and may be an electronic control type hydraulic brake device that controls an actuator in accordance with information input from the second controller 160 such that a hydraulic pressure of the master cylinder is transmitted to the cylinder.

The steering device 220 includes, for example, a steering ECU and an electric motor.

The electric motor works a force to, for example, a rack and pinion mechanism to change a direction of a steering wheel. The steering ECU drives the electric motor to change the direction of the steering wheel in accordance with information input from the second controller 160 or information input from the driving operator 80.

The third controller 180 includes, for example, a setter 181, an information acquirer 182, a determiner 183, a generator 184, an alternative generator 185, a notifier 186, an executer 187, and a storage 188.

The setter 181 updates information stored in the storage 188 based on information received from the terminal device 300, for example, using the communication device 20. The setter 181 may update each piece of information based on operation information input via the HMI 30.

The information acquirer 182 acquires various types of information based on information set by the owner X using the HMI 30 and outputs the information to the determiner 183. The various types of information include, for example, information indicating a use aspect of the automatic driving vehicle, information indicating a situation in which an occupant boards the automatic driving vehicle, information indicating a situation of the automatic driving vehicle, information indicating characteristics of an occupant using the automatic driving vehicle, information indicating a travel condition, and information indicating a change request. The information acquirer 182 may receive information set by the owner X using the terminal device 300 from the terminal device 300 or the management device 500 and acquire various types of information based on the received information. The information acquirer 182 may receive information set by the management device 500 and acquire various types of information based on the received information.

The use aspect of the automatic driving vehicle includes a use aspect by a person concerned with the owner and a use aspect by a third party. The use aspect by a person concerned with the owner is, for example, a person (registered in advance) for which at least one occupant is concerned with the owner, and a person other than the person concerned with the owner may board. The use aspect by a third party includes, for example, a case in which the automatic driving vehicle travels as a shared car or a taxi. The use aspect by a third party also includes a case in which only the automatic driving vehicle moves toward cleaning equipment in an unmanned state in response to an instruction by the owner X, arrives at the cleaning facility, and then is cleaned by a third party.

The situation in which an occupant boards the automatic driving vehicle includes a situation in which there is an occupant and a situation in which there is no occupant.

The situation of the automatic driving vehicle may be execution or non-execution of the use aspect, may be a status for each use aspect, or may be a current position or the like of the automatic driving vehicle. The situation of the automatic driving vehicle includes, for example, a case in which the automatic driving vehicle travels toward cleaning equipment or charging equipment, a case in which the automatic driving vehicle travels to take a customer of a taxi or a customer of a shared car, and a case in which the automatic driving vehicle travels to a meeting place of a customer of a shared car.

The characteristics of an occupant using the automatic driving vehicle include, for example, a standpoint in accordance with a use aspect of the automatic driving vehicle, an attribute (age or sex) of the occupant boarding the automatic driving vehicle, and personal characteristic information (a name, a nickname, or an ID) of the occupant. The characteristics of an occupant may include, for example, information indicating an authorized person or information indicating an unauthorized person (a person other than the authorized person).

The travel condition includes, for example, time information and positional information. The time information includes a starting time and an ending time of the authorized person absence traveling. The positional information includes a starting place, an ending place, and a destination of the authorized person absence traveling. The destination is a destination of the automatic driving vehicle set in the authorized person absence traveling, and may be set by the owner X, may be set by an occupant, or may be set by the generator 184.

The change request is, for example, a change request for a decided travel plan and is a request for changing at least some of the traveling conditions. For example, the change request includes a returning request, a shortening request, an extending request, an ending place change request, and a use aspect change request. The returning request is a request for ending a current travel plan and returning the automatic driving vehicle to a position at which the owner X disembarks (hereinafter, a disembarking position). The returning request may include a time until return (required time). The shortening request is a request for shortening an ending time included in the decided travel plan and includes information indicating a shortening time, an ending time after the change, or the like. The extending request is a request for extending an ending time included in the decided travel plan and includes information indicating an extension time, an ending time after the change, or the like. The ending place change request is a request for changing an ending place included in the decided travel plan. The use aspect change request is request for changing a use aspect of the automatic driving vehicle in the decided travel plan.

Based on the various types of information acquired by the information acquirer 182, the determiner 183 determines whether a predetermined condition at a timing at which the change request is acquired by the information acquirer 182 is satisfied. The predetermined condition includes, for example, a situation in which the authorized person does not board the automatic driving vehicle and a situation in which the automatic driving vehicle starts travel in accordance with the decided travel plan.

For example, based on the information indicating the use aspect of the automatic driving vehicle, the determiner 183 determines that the predetermined condition is satisfied when the use aspect of the automatic driving vehicle is equivalent to the authorized person absence traveling decided in advance. For example, the use aspect equivalent to the authorized person absence traveling decided in advance includes, for example, a cleaning service, a sharing service, a taxi service, and a charging service.

The determiner 183 determines that the predetermined condition is satisfied in some cases even when the automatic driving vehicle is traveling because of a service other than the above-described services. For example, there is a case in which the owner X disembarks and then the automatic driving vehicle is traveling toward to a parking lot or his or her home, a case in which the automatic driving vehicle waiting in his or her home is traveling toward a meeting place of the owner X, a case in which the automatic driving vehicle is traveling in accordance with a travel plan in a state in which only a child or the aged which is an unauthorized person boards.

The determiner 183 may determine whether an occupant of the automatic driving vehicle is the authorized person with reference to information indicating characteristics of the authorized person and registered in advance based on the information indicating the characteristics of the occupant using the automatic driving vehicle. Based on image data (or moving image data: hereinafter the same applies) captured by the in-vehicle camera 70, the determiner 183 may determine whether an occupant of the automatic driving vehicle is the authorized person. For example, the determiner 183 compares a feature amount of the face of the authorized person registered in advance with an analysis result using a face authentication technology by analyzing the image data captured by the in-vehicle camera 70.

The generator 184 generates a travel plan of the automatic driving vehicle. The travel plan includes a destination, a travel aspect, and a travel route. Each item included in the travel plan may differ in accordance with a type of service. The destination is a destination in which a service is supplied and is, for example, the position of cleaning equipment on a map, the position of a space in which the shared car stops or is parked on the map, the position of a charging station on the map, or the like. The travel aspect includes an aspect in which the automatic driving vehicle travels as a personal vehicle and an aspect in which the automatic driving vehicle travels as a taxi. The travel route includes a travel area (focus on a station front or focus on a downtown) and a priority road (priority of a main road).

When the determiner 183 determines that the predetermined condition is satisfied at a timing at which the change request is acquired by the information acquirer 182, the generator 184 generates a travel plan satisfying the change request (hereinafter referred to as a change plan) based on information indicating a situation of the automatic driving vehicle acquired by the information acquirer 182.

For example, when the change request is the returning request, the generator 184 generates the change plan to travel from a current position of the automatic driving vehicle to a disembarking position. When the automatic driving vehicle is on the way to cleaning equipment, the generator 184 generates a change plan for traveling toward the disembarking position immediately.

On the other hand, when the automatic driving vehicle is on the way to charging equipment and a charging residual amount of the automatic driving vehicle is equal to or greater than a threshold with reference to the charging residual amount of the automatic driving vehicle, the generator 184 may generate a travel plan for traveling toward the disembarking position immediately. When the charging residual amount of the automatic driving vehicle is less than the threshold, the generator 184 may generate a travel plan for traveling to closest charging equipment and traveling toward the disembarking position after charging is completed.

For example, when the change request is a request for changing the travel condition (for example, a shortening request, an extending request, or an ending place change request), the generator 184 generates a change plan (for example, a change plan until a requested ending time or until return to a requested home return place) satisfying a travel condition related to the requested change. For example, when cleaning work is being performed at cleaning equipment and a shortening request is given from the owner X, the generator 184 generates a change plan for traveling the disembarking position immediately. For example, when there is an extending request in the middle of use of the automatic driving vehicle as a shared car, the generator 184 may extend the traveling as the shared car or may travel the automatic driving vehicle as a taxi after the use as the shared car ends. In this way, when a required time is changed in the shortening request, the extending request, or the like, the generator 184 may change the use aspect of the automatic driving vehicle.

The generator 184 determines whether the change request is satisfied when the generator 184 generates the change plan, and changes the change request when the change request can be satisfied. For example, when the automatic driving vehicle can return to the disembarking position within a predetermined time in response to the returning request, the generator 184 determines that the change request can be satisfied. When the currently performed travel plan can be changed to the travel plan matching the requested travel condition, the generator 184 determines that the change request can be satisfied.

The generator 184 determines whether an unauthorized person boards the automatic driving vehicle when the generator 184 generates the change plan. When the generator 184 determines that the unauthorized person boards the returning request, the generator 184 searches for a transfer vehicle. The transfer vehicle is another vehicle in which the unauthorized person boarding the automatic driving vehicle can board and by which the travel plan currently performed by the automatic driving vehicle can be performed instead. When the transfer vehicle is searched for and obtained, the generator 184 generates a travel plan for traveling the automatic driving vehicle to a joining place with the transfer vehicle (hereinafter referred to as a transfer place). After the unauthorized person is allowed to disembark at the transfer place, the generator 184 generates a change plan in which the transfer place is set as a starting place.

When the unauthorized person boarding the automatic driving vehicle approves of non-preparation of a transfer vehicle, the generator 184 may allow the unauthorized person to disembark immediately, and then may generate a change plan in which the place at which the unauthorized person is allowed to disembark is set as a starting place. When the unauthorized person boarding the automatic driving vehicle disapproves of transferring to the transfer vehicle, the generator 184 may end the use of the automatic driving vehicle by the unauthorized person and then generate a change plan. When the automatic driving vehicle may not travel in accordance with a travel plan satisfying the change request after the unauthorized person disembarks (the change plan may not be generated), the generator 184 may request the alternative generator 185 to generate an alternative.

When the generator 184 may not generate the change plan (that is, when the generator 184 determines that the change request may not be satisfied), the alternative generator 185 generates the alternative. For example, the alternative generator 185 searches for another vehicle which can travel in accordance with the travel plan satisfying the change request (hereinafter referred to as an alternative vehicle) among a plurality of other vehicles registered in advance.

When the alternative vehicle is searched for and obtained, the alternative generator 185 requests the alternative vehicle to travel in accordance with the change plan. The alternative generator 185 may transmit necessary information to the management device 500 or the vehicle control device 5 of the alternative vehicle and may request the management device 500 or the vehicle control device 5 of the alternative vehicle to generate an alternative.

The notifier 186 transmits information regarding the change plan generated by the generator 184 to the terminal device 300 by using the communication device 20 to notify the authorized person of the change plan. When the alternative is not generated by the alternative generator 185 or the change plan is not generated by the generator 184, the notifier 186 may notify the authorized person that the alternative or the change plan is not generated.

The executer 187 executes a process of causing the automatic driving vehicle to travel in accordance with the travel plan (or the change plan) generated by the generator 184. For example, the executer 187 instructs the navigation device 50 to decide a route to the destination based on the travel plan (or the change plan). Thus, the MPU 60 decides a recommended lane, the action plan generator 140 decides an event, or the action plan generator 140 generates a target trajectory. Through this process, the second controller 160 controls each device based on information output from the first controller 120, and thus the automatic driving vehicle can travel in accordance with the travel plan.

The storage 188 is, for example, a hard disk drive (HDD), a flash memory such as a rand access memory (RAM), a read-only memory (ROM), a solid-state drive (SSD), or the like. The storage 188 stores, for example, information regarding the travel plan, information regarding the authorized person, various types of information to be used for the third controller 180 to perform the above-described processes, and the like.

### [Process Flow]

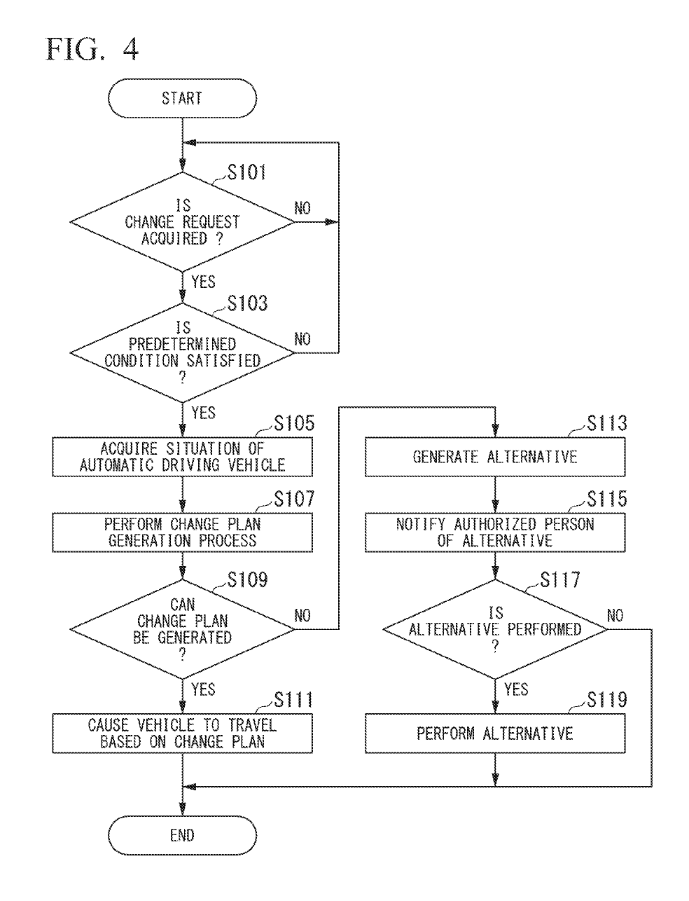

Hereinafter, a flow of each process by the third controller 180 according to the embodiment will be described with reference to a flowchart. FIG. 4 is a flowchart illustrating an example of the flow of the process by the third controller 180.

First, the determiner 183 determines whether the information acquirer 182 acquires the change request (step S101). When determiner 183 determines that the information acquirer 182 acquires the change request, the determiner 183 determines whether the predetermined condition is satisfied (step S103). When the determiner 183 determines that the predetermined condition is satisfied, the information acquirer 182 acquires information indicating a situation of the automatic driving vehicle (step S105). Subsequently, the generator 184 generates the change plan in accordance with a situation of the automatic driving vehicle (step S107).

Then, the executer 187 determines whether the generator 184 can generate the change plan (step S109). When the generator 184 can generate the change plan, the executer 187 executes a process of causing the automatic driving vehicle to travel in accordance with the change plan (step S111). Conversely, when the generator 184 may not generate the change plan in step S109, the alternative generator 185 generates an alternative (step S113). Then, the notifier 186 notifies the authorized person of the alternative (step S115). The executer 187 determines whether the authorized person gives an instruction to perform the alternative (step S117). When the instruction to perform the alternative is given, the executer 187 executes a process of performing the alternative (step S119).

According to the above-described first embodiment, the generator 184 that generates a first travel plan of the automatic driving vehicle; the controller (120, 160, 180) that causes the automatic driving vehicle to travel based on the first travel plan generated by the generator 184; and the information acquirer 182 that acquires a change request for changing the first travel plan generated by the generator 184. The generator 184 generates a second travel plan satisfying the change request in accordance with a situation of the automatic driving vehicle when the information acquirer 182 acquires the change request in a situation in which the authorized person who has a predetermined authority to use the automatic driving vehicle does not board the automatic driving vehicle and the automatic driving vehicle starts traveling in accordance with the first travel plan. Thus, it is possible to expand utilization of the vehicle when a change in a use schedule is desired.

### Second Embodiment

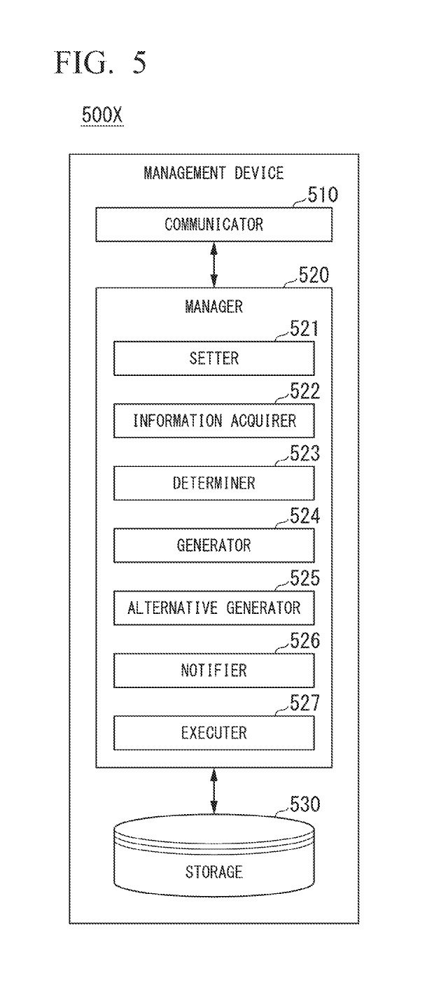

Next, a management device 500X according to a second embodiment will be described with reference to FIG. 5. The management device 500X according to the second embodiment has a configuration equivalent to the third controller included in the vehicle control device 5 according to the first embodiment.

FIG. 5 is a diagram illustrating the configuration of the management device 500X according to the second embodiment. The same names are given to constituents that have the same functions as those of the first embodiment and the detailed description will be omitted. As illustrated in FIG. 5, the management device 500X includes a communicator 510, a manager 520, and a storage 530. The communicator 510 includes, for example, a communication interface such as NIC. The storage 530 is, for example, an HDD, a flash memory such as a RAM, a ROM, or an SSD, or the like.

The storage 530 stores, for example, information regarding a travel plan, information regarding the authorized person, various types of information to be used for the manager 520 to perform the following processes.

The manager 520 includes, for example, a setter 521, an information acquirer 522, a determiner 523, a generator 524, an alternative generator 525, a notifier 526, and an executer 527. The manager 520 performs the same processes as those described above based on information received from the vehicle control device 5 or information received from the terminal device 300, using the communicator 510.

According to the above-described second embodiment, it is possible to obtain the same advantages as those of the first embodiment.

### [Hardware Configuration]

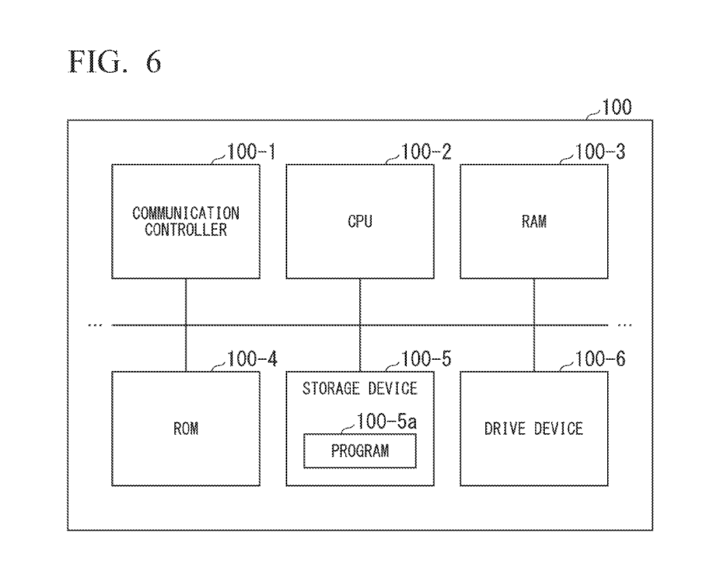

FIG. 6 is a diagram illustrating an example of a hardware configuration of the automatic driving control device 100 according to the embodiment. As illustrated, the automatic driving control device 100 is configured such that a communication controller 100-1, a CPU 100-2, a random access memory (RAM) 100-3 that is used as a working memory, a read-only memory (ROM) 100-4 that stores a boot program or the like, a storage device 100-5 such as a flash memory or a hard disk drive (HDD), a drive device 100-6, and the like are connected to each other via an internal bus or a dedicated communication line.

The communication controller 100-1 performs communication with a constituent element other than the automatic driving control device 100. The storage device 100-5 stores a program 100-5a that is executed by the CPU 100-2. The program is loaded on the RAM 100-3 by a direct memory access (DMA) controller (not illustrated) to be executed by the CPU 100-2.

Thus, some or all of the first controller 120, the second controller 160, and the third controller 180 are realized.

The above-described embodiment can be expressed as follows:

a vehicle control device including a storage device that stores a program and a hardware processor,

wherein the hardware processor executes the program stored in the storage device to generate the first travel plan of the automatic driving vehicle, to cause the automatic driving vehicle to travel based on the first travel plan generated by the generator, and to acquire a change request for changing the first travel plan generated by the generator, and

wherein a second travel plan satisfying the change request is generated in accordance with a situation of the automatic driving vehicle when the change request is acquired in a situation in which an authorized person who has a predetermined authority to use the automatic driving vehicle does not board the automatic driving vehicle and the automatic driving vehicle starts traveling in accordance with the first travel plan.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

For example, the management device 500 according to the first embodiment can also have a configuration in which a travel plan or a change plan is generated as in the management device 500X according to the second embodiment.

What is claimed is:

1. A vehicle control system comprising:
a generator configured to generate a first travel plan of an automatic driving vehicle;
a controller configured to cause the automatic driving vehicle to travel based on the first travel plan generated by the generator; and
an acquirer configured to acquire a change request for changing the first travel plan generated by the generator,
wherein the generator generates a second travel plan satisfying the change request in accordance with a situation of the automatic driving vehicle when the acquirer acquires the change request in a situation in which an authorized person who has a predetermined authority to use the automatic driving vehicle does not board the automatic driving vehicle and the automatic driving vehicle starts traveling in accordance with the first travel plan.

2. The vehicle control system according to claim 1,
wherein the change request includes a request for changing a travel condition including at least one of time information and positional information included in the first travel plan, and
wherein, as the second travel plan, the generator generates a travel plan satisfying a travel condition related to the requested change.

3. The vehicle control system according to claim 1,
wherein the change request includes return to a position at which the automatic driving vehicle allows the authorized person to disembark, and
wherein, as the second travel plan, the generator generates a travel plan for causing the automatic driving vehicle to travel toward the position at which the automatic driving vehicle allows the authorized person to disembark.

4. The vehicle control system according to claim 1,
wherein, as the second travel plan, the generator generates a travel plan in which a place at which use of the automatic driving vehicle by a person other than the authorized person ends is set as a starting place when the acquirer acquires the change request and the automatic driving vehicle allows the person other than the authorized person to board.

5. The vehicle control system according to claim 1, further comprising:
a notifier configured to notify the authorized person of the second travel plan generated by the generator.

6. The vehicle control system according to claim 1, wherein the generator generates a third travel plan which is a substitute when the generator is not able to generate the second travel plan.

7. The vehicle control system according to claim 1, further comprising:
an alternative generator configured to search for another automatic driving vehicle which is able to execute a travel plan satisfying the change request when the generator is not able to generate the second travel plan.

8. The vehicle control system according to claim 1, wherein the controller causes the automatic driving vehicle to travel based on the second travel plan generated by the generator.

9. A vehicle control method of causing one or more computers to perform:
generating a first travel plan of an automatic driving vehicle;
causing the automatic driving vehicle to travel based on the first travel plan generated by the generator; and
acquiring a change request for changing the first travel plan generated by the generator,
wherein a second travel plan satisfying the change request is generated in accordance with a situation of the automatic driving vehicle when the change request is acquired in a situation in which an authorized person who has a predetermined authority to use the automatic driving vehicle does not board the automatic driving vehicle and the automatic driving vehicle starts traveling in accordance with the first travel plan.

10. A program causing one or more computers to perform:
generating a first travel plan of an automatic driving vehicle;
causing the automatic driving vehicle to travel based on the first travel plan generated by the generator; and
acquiring a change request for changing the first travel plan generated by the generator,
wherein a second travel plan satisfying the change request is generated in accordance with a situation of the automatic driving vehicle when the change request is acquired in a situation in which an authorized person who has a predetermined authority to use the automatic driving vehicle does not board the automatic driving vehicle and the automatic driving vehicle starts traveling in accordance with the first travel plan.
